(19) United States
(12) Patent Application Publication
(10) Pub. No.: US 2016/0304682 A1
(43) Pub. Date: Oct. 20, 2016

(54) TRANSPARENT COMPOSITE FILM HAVING A LOW COEFFICIENT OF THERMAL EXPANSION

(71) Applicant: Songlin Liu, (US)

(72) Inventor: Songlin Liu, (US)

(21) Appl. No.: 14/782,810

(22) PCT Filed: Apr. 7, 2014
(86) PCT No.: PCT/EP2014/056914

§ 371 Date: Oct. 7, 2015

(30) Foreign Application Priority Data
Apr. 9, 2013 (EP) 13162949.5

(51) Int. Cl. C08J 5/24; C08J 5/04; C08J 5/18

(52) U.S. Cl. CPC C08J 5/24; C08J 5/18; C08J 5/043; C08J 2375/06

(57) ABSTRACT

The invention relates to a transparent composite composition and film which has an excellent optical transparency, a very low coefficient of thermal expansion, a good flexibility, a high thermal stability and a good chemical resistance, and a method to produce the same. This composite, upon being cured and fabricated into films or sheets, can be used to replace glass panels for applications as the substrates in liquid crystal displays, colour filters, touch panels, electroluminescent devices, organic light emitting diode displays, electrophoretic displays, lenses in electronics devices, and solar cells, etc.

This invention relates to a transparent composite composition and film which has an excellent optical transparency, a very low coefficient of thermal expansion, a good flexibility, a high thermal stability and a good chemical resistance, and a method to produce the same. This composite composition, upon being cured and fabricated into films or sheets, can be used to replace glass panels for applications as the substrates in liquid crystal displays, colour filters, touch panels, electroluminescent devices, organic light emitting diode displays, electrophoretic displays, lenses in electronics devices, and solar cells, etc.

Glass panels have been widely used in displays as the substrates for the deposition of thin-film-transistors (TFT). The TFT deposited glass panels are the backplanes for liquid crystal displays, electrophoretic displays and organic light emitting diode displays. In addition, glass panels are also used to fabricate color filters, touch panels and solar cell substrates.

In recent years, there has been considerable interest in using polymer substrates to replace glass panels for flat panel displays because of their advantages of being thin, light, robust and flexible. Furthermore, polymer substrates offer the possibility of reducing production cost due to the compatibility with the roil-to-roll process. There are a few polymer substrates commercially available, such as polycarbonate and co-polycarbonate (PC), polyether sulfone (PES), poly-ethylene terephthalate (PEN), polyimide (PI) etc.

However, to replace glass plates as substrates, polymer films must meet a few property requirements for display applications, which include high transmittance, low have and birefringence, good thermal properties and chemical resistance, and a low coefficient of thermal expansion (CTE). Among these properties, the low CTE requirement is the most challenging as most amorphous polymer materials exhibit a high CTE. In the backplane fabrication, the TFT layers, typically inorganic materials with low CTEs, are directly deposited onto the substrate at high temperatures.

A mismatch of CTEs between the inorganic TFT layers and the substrate will result in severe stress and even cracking of the TFT layers. A few approaches have been adopted to reduce the CTEs of polymeric materials, which include the addition of nanoparticles and nanofibers, the composite approach using glass fiber reinforcement, and the syntheses of polyimides. Among these approaches, composite approach seems to be more promising due to its low cost and mature manufacturing technology.

For the fabrication of low CTE fiberglass reinforced transparent composite films, a few studies have been reported to develop specific matrix resins for the composite films. Typical matrices used to manufacture transparent composite films with a low CTE include cycloaliphatic epoxies as disclosed in WO 2010/104191, WO 2011/062290, US 2010/0216912, US 2010/0009149, U.S. Pat. No. 7,132,154 B2 etc, acrylates as described in US 2007/0219309, U.S. Pat. No. 7,250,209 etc, sol-gel as embodied in US 2010/0178478A1 and US 2011/0052890 A1 etc, and silsesquioxanes as claimed in TW 201041945 A1.

However, epoxy and acrylate matrices generally show coloration while composite films based on sol-gel matrices are easy to crack due to post cure at room temperature and exhibit low transmittance (US 2011/0052890 A1). Therefore, transparent composite films fabricated from the combination of fiberglass with the above mentioned matrices still need improvements in transparency, colorlessness and cracking resistance.

The present invention has the objective of overcoming at least some of the drawbacks in the art. In particular, the invention has the object of providing an improved composite film for optoelectronic applications.

This objective is achieved by a composite film comprising a matrix and a glass filler at least partially embedded in the matrix, wherein the matrix comprises a cross-linked polyurethane polymer, wherein the composite film has a light transmittance of more than 80%, a coefficient of thermal expansion of less than 40 ppm/K and the film has a thickness of less than 500 μm.

The composite film according to the invention has a high transparency, good cracking resistance and flexibility, and low coloration. The transparent composite films fabricated therefore will meet the requirements as the substrates for TFT deposition. The TFT deposited backplanes can be used for liquid crystal displays, colour filters, touch panels, electroluminescent devices, organic light emitting diode displays, electrophoretic displays, lenses in electronics devices, and solar cells.

The composite film may be in the form of one layer comprising a cross-linked polyurethane matrix and a glass filler. Alternatively, the composite film may comprise several layers of cross-linked polyurethane matrixes comprising glass fillers if so desired.

In its broadest form, the composite film according to the invention is formed by a cross-linked polyurethane polymer matrix and a glass filler.

A “cross-linked polyurethane polymer” is meant to be understood as a polymer comprising polyurethane polymer chains which form a three-dimensional network. This can be achieved, for example, by employing starting materials (—NCO compounds and/or —NCO-reactive compounds) with an average functionality of greater than two or by using chain extension agents for prepolymer chains with an (average) functionality of greater than two. Another example is to use reactive cross-linking groups in the polymer chain such as (meth)acrylate groups. One would then use the term “urethane (meth)acrylate”.

On the isocyanate side, aliphatic polyisocyanates are preferred due to their light stability. Besides, it is also possible to employ proportionately modified diisocyariates having a uretdione, isocyanurate, urethane, allophanate, biuret, iminooxadiazinedione and/or oxadiazinetrione structure and unmodified polyisocyanates containing more than 2 —NCO groups per molecule, for example 4-isocyanatomethyloctane 1,8-diisocyanate (nonane triisocyanate) or triphenylmethane 4,4′,4″-triisocyanate.

These are preferably polyisocyanates or polyisocyanate mixtures of the above-mentioned type containing exclusively aliphatically and/or cycloaliphatically bonded isocyanate groups and having an average NCO functionality of the mixture of 2 to 4.

Suitable polyols for the polyurethane formation include polyester polyols, polyacrylate polyols, polyurethane polyols, polycarbonate polyols, polyether polyols, polyester-polyacrylate polyols, polyurethane polyacrylate polyols, polyurethane polyester polyols, polyurethane polyether polyols, polyurethane polycarbonate polyols and polyester polycarbonate polyols known per se in polyurethane technology.

With respect to the properties of the polyol, it is advantageous that the —OH content is rather high, in particular ≧10 weight-%, more preferred ≧12 weight-% to ≦18 weight-% and most preferred ≧13 weight-% to ≦16 weight-%. It has been found that when using polyols with a lower OH content the matrix material will become too soft. The hydroxyl content correlates with the hydroxyl number, which is available by titration of the polyol, according to the following equation known to a skilled person in the art:

OH number=(56100/1700)*OH content

Procedures for the determination of the —OH number may be found in the corresponding norms and standards such as DIN 53240.

Particularly considered is a polyester polyol having hydroxyl content of ≧10 weight-%, more preferred ≧12 weight-% to ≦18 weight-% and most preferred ≧13 weight-% to ≦16 weight-%.

A typical resin composition for producing the matrix of the composite film according to the present invention comprises from 45-70 wt. % of a polyisocyanate, preferably an aliphatic polyisocyanate such as HDI, THDI, H-MDI and IPDI, and their dimers and trimers from 25-45 wt. % of a polyol compound, preferably a polyester polyol.

The term “glass” according to the present invention encompasses glass fibers. Glass fibers are well known in the art and are preferably used in the form of weavings, monofilaments and chopped short fibers.

The types of glass materials most commonly used in the art are mainly E-glass (alumino-borosilicate glass with less than 1% w/w alkali oxides, mainly used for glass-reinforced plastics), but also A-glass (alkali-lime glass with little or no boron oxide), E-CR-glass (alumino-lime silicate with less than 1% w/w alkali oxides, has high acid resistance), C-glass (alkali-lime glass with high boron oxide content, used for example for glass staple fibers), D-glass (borosilicate glass with high dielectric constant), R-glass (alumino silicate glass without MgO and CaO with high mechanical requirements), and S-glass (alumino silicate glass without CaO but with high MgO content with high tensile strength). T-glass is a North American variant of C-glass.

In the present invention, the glass filler is preferably E-glass, S-glass and/or T-glass.

Regarding the properties of the composite film, its light transmittance shall be more than 80% and the preferred light transmittance shall be more than 85%, most preferred ≧85% to ≦99%. This parameter can be determined according to ASTM D1003 in the wavelength range from 330 to 900 nm.

The CTE of the composite film of the present invention is less than 40 ppm/K and the preferred CTE is less than 20 ppm/K, most preferred ≧1 ppm/K to ≦15 ppm/K.

The coefficient of thermal expansion has the general meaning as employed in the art, i.e., as measured according to ASTM E831. Preferably, it can be measured according to ASTM E831 using a Thermal Mechanical Analyzer (TMA) in a nitrogen environment with a heating rate of 10° C./min and at a temperature range of from 30 to 200° C. The tension force applied on the sample during CTE measurement can be 0.1. N.

Whereas the total thickness of the composite film according to the invention is less than 500 μm (preferably 10-200 μm), its shape is not restricted per se. For example, planar and non-planar shapes are equally possible. A product designer has great freedom in his designs when using a composite film according to the invention.

The embodiments and aspects of the present invention will be described in more detail below. They may be combined freely unless the context clearly indicates otherwise.

In one embodiment of the composite film according to the invention the glass filler is present in form of glass fabrics, non-woven clothes, glass monofilanients or chopped glass fibers.

If a glass fabric or glass cloth is employed, the thickness of said fabric or cloth plays a significant role in defining the preferred properties of the composite film. The thickness of the glass fabric is preferably in the range of 20-200 μm and the preferred thickness is 20-100 μm. If the thickness is within the preferred ranges, composite films having excellent CTEs, and exhibiting superior flexibility, crack resistance and transparency are obtained. Using fabrics and clothes of higher thicknesses will result in composite films of smaller flexibility.

Accordingly, in another embodiment of the composite film according to the invention the glass filler is present in form of glass fabrics having a thickness of 20 to 200 μm, preferably of ≧30 to ≦100 μm.

In another embodiment of the composite film according to the invention the polyurethane polymer has been prepared from a mixture comprising at least one aliphatic polyisocyanate and at least one polyester polyol.

In particular, the polyurethane can be prepared from a mixture comprising at least one of the following polyisocyanate compounds 1) and at least one of the following polyols 2):

1) Tetramethylene diisocyanate, hexatnethylene diisocyanate (HDI), 2-methylpentamethylene diisocyanate, 2,2,4-trimethyl-hexamethylene diisocyanate (THDI), dodecanemethylene diisocyanate, 1,4-diisocyanatocyclohexane, 3-isocyanatomethyl-3,3,5-trimethylcyclohexyl isocyanate (isophorone diisocyanate=IPDI), 4,4′-diisocyanatodicyclohexylmethane (Desmodur® W), 4,4′-diisocyanato-3,3′-dimethyldicyclohexylmethane, 4,4′-diisocyanato-2,2-dicyclohexylpropane. For the purposes of modification, additional trimers, urethanes, biurets, allophanates or uretdiones of the above-mentioned diisocyanates can be used.

2) Polycondensates, known per se, of di- and optionally tri-and tetraols and di- and optionally tri- and tetracarboxylic acids or hydroxycarboxylic acids or lactones. Instead of the free polycarboxylic acids, it is also possible to use the corresponding polycarboxylic anhydrides or corresponding polycarboxylates of lower alcohols for the preparation of the polyesters.

Examples of suitable diols are ethylene glycol, butylene glycol, diethylene glycol, triethylene glycol, polyalkylene glycols, such as polyethylene glycol, furthermore 1,2-propanediol, 1,3-propanediol, 1,3-butanediol, 1,4-butanediol, 1,6-hexanediol and isomers, neopentyl glycol or neopentyl glycol hydroxypivalate, where 1,6-hexanediol and isomers, neopentyl glycol and neopentyl glycol hydroxypivalate are preferred. In addition, it is also possible to employ polyols, such as trimethylolpropane, glycerol, erythritol, pentaerythritol, trimethylolbenzene or trishydroxyethyl isocyanurate.

Dicarboxylic acids which can be employed are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid and/or 2,2-dimethylsuccinic acid. The corresponding anhydrides can also be used as acid source.

Preferred acids are aliphatic or aromatic acids of the above-mentioned type. Particular preference is given to adipic acid, isophthalic acid and optionally trimellitic acid.

Other monomers such thiols and amines that can react with aliphatic isocyanates to form transparent matrices can also be used.

In another embodiment of the composite film according to the invention the polyurethane polymer has been prepared from unsaturated polyurethane based resins. Unsaturated polyurethane based resins generally comprise acrylate-modified polyurethanes. These are known, for example, from WO-A-2008125200. Such unsaturated polyurethane based resins are obtainable, for example, by reacting A) polyisocyanates, B) isocyanate-reactive block copolymers, and C) compounds having groups which react on exposure to actinic radiation with ethylenically unsaturated compounds with polymerization (radiation-curing groups).

In component C), alpha,beta-unsaturated carboxylic acid derivatives, such as acrylates, meth- acrylates, maleates, fumarates, maleimides, acrylamides and furthermore vinyl ethers, propylene ether, allyl ether and compounds containing dicyclopentadienyl units and olefinically unsaturated compounds, such as styrene, alpha-methylstyrene, vinyltoluene, vinylcarbazole, olefins, such as, for example, 1-octene and/or 1-decene, vinyl esters, such as, for example, (meth)acrylonitrile, (meth)acrylamide, methacrylic acid, acrylic acid and any desired mixtures thereof may be used. Acrylates and methacrylates are preferred, and acrylates are particularly preferred.

Esters of acrylic acid or methacrylic acid are generally referred to as acrylates or methacrylates. Examples of acrylates and methacrylates which may be used are methyl acrylate, methyl methacrylate, ethyl acrylate, ethyl methacrylate, ethoxyethyl acrylate, ethoxyethyl methacrylate, n-butyl acrylate, n-butyl methacrylate, tert-butyl acrylate, tert- butyl methacrylate, hexyl acrylate, hexyl methacrylate, 2-ethylhexyl acrylate, 2-ethylhexyl methacrylate, butoxyethyl acrylate, butoxyethyl methacrylate, lauryl acrylate, lauryl methacrylate, isobornyl acrylate, isobornyl methacrylate, phenyl acrylate, phenyl methacrylate, p-chlorophenyl acrylate, p-chlorophenyl methacrylate, p-bromophenyl acrylate, p-bromophenyl methacrylate, trichlorophenyl acrylate, trichlorophenyl methacrylate, tribromophenyl acrylate, tribromophenyl methacrylate, pentachlorophenyl acrylate, pentachlorophenyl methacrylate, pentabromophenyl acrylate, pentabromophenyl methacrylate, pentabromobenzyl acrylate, pentabromobenzyl methacrylate, phenoxyethyl acrylate, phenoxyethyl methacrylate, phenoxyethoxyethyl acrylate, phenoxyethoxyethyl methacrylate, 2-naphthyl acrylate, 2-naphthyl methacrylate, 1,4-bis-(2-thionaphthyl)-2-butyl acrylate, 1,4-bis-(2-thionaphthyl)-2-butyl methacrylate, bisphenol A diacrylate, bisphenol A dimethacrylate, tetrabromobisphenol A diacrylate, tetrabromobisphenol A dimethacrylate, 2,2,2-trifluoroethyl acrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl acrylate and/or 2,2,3,3,3-pentafluoropropyl methacrylate.

When a particular smooth surface of the composite film is required, it can be advantageous to provide the film with a coating layer which does not comprise any glass filler. The coating layer is preferably the same cross-linked polyurethane as the cross-linked polyurethane matrix of the corresponding composite film, but without said glass filler. Hence, in another embodiment of the film according to the invention the film may further comprise at least one coating layer. This coating layer is not included in the calculation of the film thickness. As a coating layer, any planarizing substance may be used. For reasons of chemical compatibility, it is preferred that the coating layer comprises the polyurethane polymer of the matrix material.

Another aspect of the present invention is a process for the manufacture of a composite film, comprising the following steps:
preparing a resin composition for a cross-linked polyurethane matrix, the resin composition comprising a polyisocyanate, preferably an aliphatic isocyanate, a polyol and optionally a defoamer, a thermostabilizer and a wetting agent;
providing a glass fabric or non-woven glass cloth;
contacting said glass fabric or non-woven glass cloth with the resin composition;
curing the resin composition;
   wherein the obtained film has a light transmittance of more than 80%, a coefficient of thermal expansion of less than 40 ppm/K and a thickness of less than 500 μm.

Regarding the details of polyurethane materials, glass types, etc, the comments made in connection with the composite film according to the invention also apply here. For reasons of brevity they are not repeated.

The application of the resin composition may, for example, be effected by means of a doctor blade or by extrusion. In addition, several layers may be laminated together to form a composite film. The individual layers may be layers without a glass filler and layers with a glass filler.

It is also possible to contact the glass with the resin composition by immersing the glass material into the resin composition.

In one embodiment of the process according to the invention the glass fabric or glass cloth has a thickness in the range of from 10 to 200 μm.

With respect to the curing step, in one embodiment of the method according to the invention the curing step comprises thermal curing and/or radiation curing. For example, “dual cure” systems may be employed where a prepreg is thermally treated for easier processing and then radiation hardened to give the final product.

It is possible to employ a support or substrate when contacting the glass material with the resin composition. In another embodiment of the method according to the invention the contacting said glass fabric or non-woven glass cloth with the resin composition is conducted on a support and the support is a release film. This represents a very efficient means for manufacturing the composite film according to the present invention. A release film may be a PTFE- or silicone-impregnated fabric or paper.

In another embodiment of the method according to the invention the resin composition comprises at least one aliphatic polyisocyanate and at least one polyester polyol. Preference is given to a polyester polyol having hydroxyl content of ≧10 weight %, more preferred ≧12 weight % to ≦18% and most preferred ≧13% to ≦16%.

In a particular preferred embodiment of the process according to the present invention, a resin composition comprising of from 55 to 70 wt. % of aliphatic polyisocyanates, from 25 to 40 wt. % of a polyester polyol and from 0.01 to 0.05 wt. % of a defoamer is used, followed by placing a glass fabric or glass cloth having a thickness of from 15 to 80 μm on a substrate, preferably a PTFE coated release fabric, coating the glass fabric or glass cloth with the resin composition and curing the composition. This yields a composite film having a light transmittance of more than 80%, a coefficient of thermal expansion of less than 20 ppm/K and a thickness of less than 200 μm.

The invention is also concerned with an assembly comprising a support and an optical element supported by the support, wherein the support comprises a composite film comprising a matrix and a glass filler at least partially embedded in the matrix, wherein the matrix comprises a cross-linked polyurethane polymer and wherein the composite film has a light transmittance of more than 80%, a coefficient of thermal expansion of less than 40 ppm/K and a thickness of less than 500 μm.

Regarding the assembly according to the invention, it is preferred that the composite film is a composite film according to the invention.

In another embodiment of the assembly according to the invention the optical element is a liquid crystal element, a color filter, a touch panel element, an electroluminescent element, a light emitting diode, an organic light emitting diode, an electrophoretic display element, a thin film transistor, a lens element or a photovoltaic element.

Lastly, the invention is directed towards an electronic device comprising an assembly according to the invention.

### EXAMPLES

Hereinafter, the present invention will be explained in more detail below with reference to Examples, but the present invention is not limited thereto.

### Measurements:

1. Linear Coefficient of Thermal Expansion (CTE)

The CTE was measured according to ASTM E831 using a Thermal Mechanical Analyzer (TMA) in a nitrogen environment with a heating rate of 10° C./min and a temperature range of 30 to 200° C. The tension force used was 0.1 N.

2. Light Transmittance

The measurement of total light transmittance was conducted according to ASTM D1003 in the wavelength range from 330 to 900 nm.

### EXAMPLE 1

A glass cloth made of S-glass (thickness 40 μm, refractive index 1.52, Hexcel HexForce 4180, Satin, 48 g/m²) was used for impregnation. This glass cloth was impregnated with a resin composition composed of 67.4% by weight of Desmodur N3900 (Polyisocyariate based on hexamethylene diisocyanate (HDI), NCO content of 23.5 weight-%, viscosity of 730 mPa·s at 23° C., Bayer A G, Leverkusen, Germany), 32.4% by weight of Desmophen VPLS2249/1 (polyester polyol, OH content of 15.5 weight-%, viscosity of 1900 mPa·s at 23° C., Bayer A G, Leverkusen, Germany) and 0.02% by weight of silicone-free defoamer BYK 052 (BYK). Impregnation was performed at an elevated temperature of 55° C. The resin-impregnated glass cloth was placed on a PTFE coated release fabric. Curing was conducted at 80° C. for 1 hr, 120° C. for 30 min and 150° C. for 1 hr. The composite film fabricated has a coefficient of thermal expansion of 6.0 ppm/K, a thickness of 141 μm and a total light transmittance of 90.1%. Also, when the composite film was rolled on a circular cylinder having a diameter of 10 cm, no cracking and whitening were observed and the film was flexible.

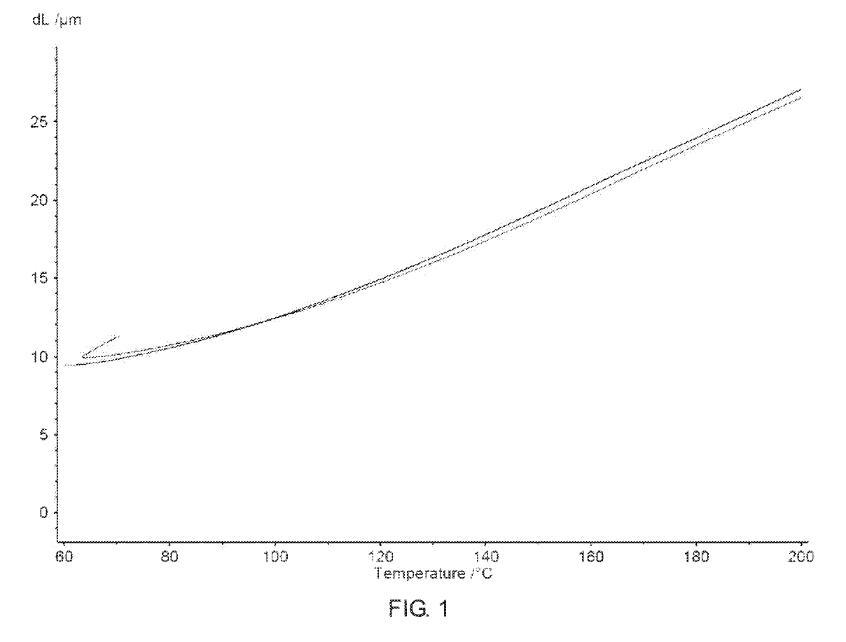

Curves for the determination of the coefficient of thermal expansion are shown in FIG. 1,

### EXAMPLE 2

A sample film having a thickness of 199 μm was prepared in the same manner as described in Example 1 except that resin composition of 65.1% by weight of Desmodur N3900, 34,5% by weight of Desmophen XP2488 (polyester polyol, OH % content of 16.0%, viscosity of 14500 mPa·s at 23° C., Bayer A G, Leverkusen, Germany) and 0.02% by weight of silicone-free defoamer BYK 052 was used. The composite film has a coefficient of thermal expansion of 8.9 ppm/K, and a total light transmittance of 90.60%.

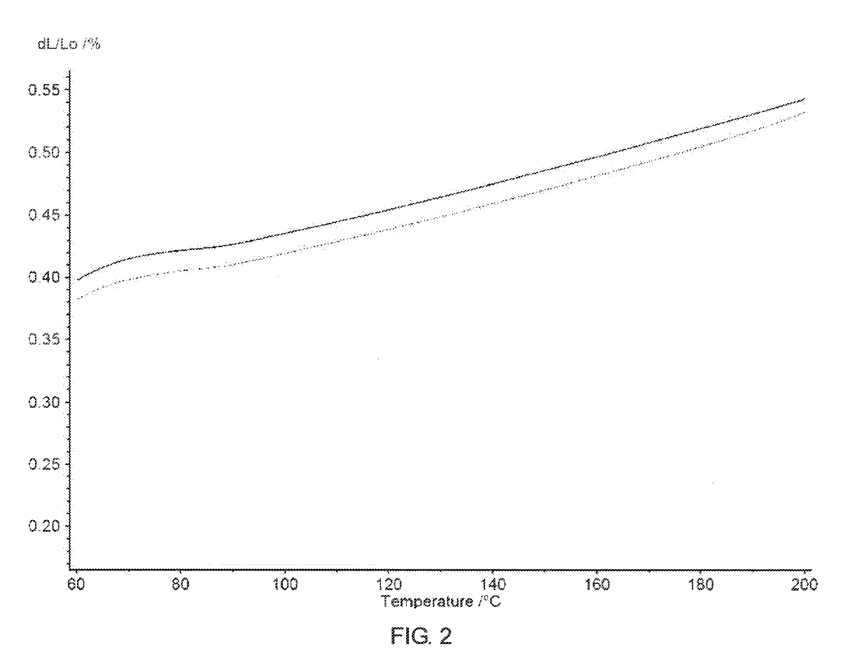

Curves for the determination of the coefficient of thermal expansion are shown in FIG. 2.

### EXAMPLE 3

A sample film having a thickness of 85 μm was prepared in the same manner as described in Example 1 except that a resin composition of 67.98% by weight of Desmodur N Z1 (Aliphatic polyisocyanate, NCO % content of 20.0%, viscosity of 3000 mPa·s at 23° C., Bayer A G, Leverkusen, Germany), 31.83% by weight of Desmophen VPLS2249/1 and 0.02% by weight of silicone-free defoamer BYK 052 was used. The composite film has a coefficient of thermal expansion of 7.3 ppm/K, and a total light transmittance of 88.60%.

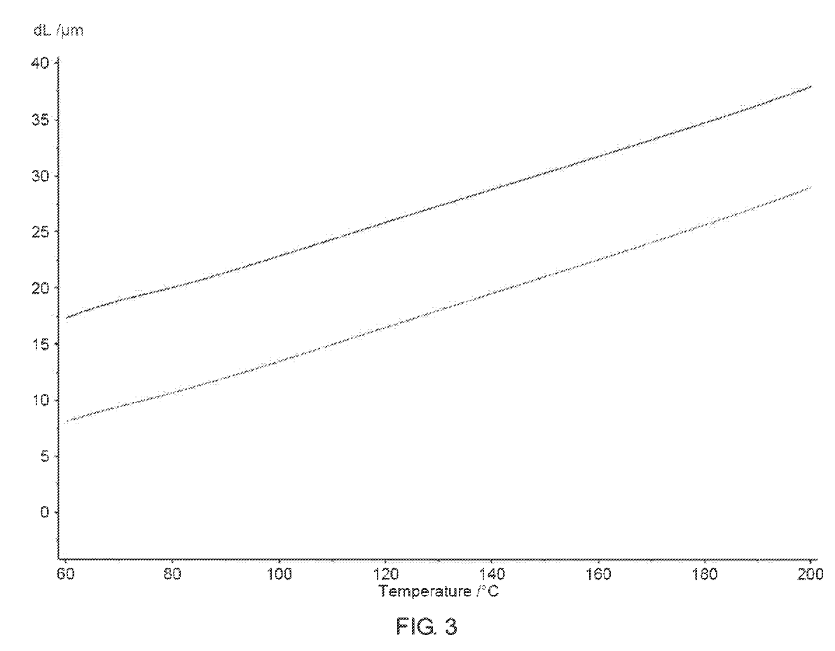

Curves for the determination of the coefficient of thermal expansion are shown in FIG. 3.

### EXAMPLE 4

A sample film having a thickness of 87 μm was prepared in the same manner as described in Example 1 except that a resin composition of 53.15% by weight of Desmodur I (Isophorone diisocyanate (IPDI), NCO % content of 37.5%, viscosity of 10 mPa·s at 25° C., Bayer A G, Leverkusen, Germany), 46.65% by weight of Desmophen VPLS2249/1 and 0.02% by weight of silicone-free defoamer BYK 052 was used. The film has a coefficient of thermal expansion of 7.5 ppm/K, and a total light transmittance of 86.0%.

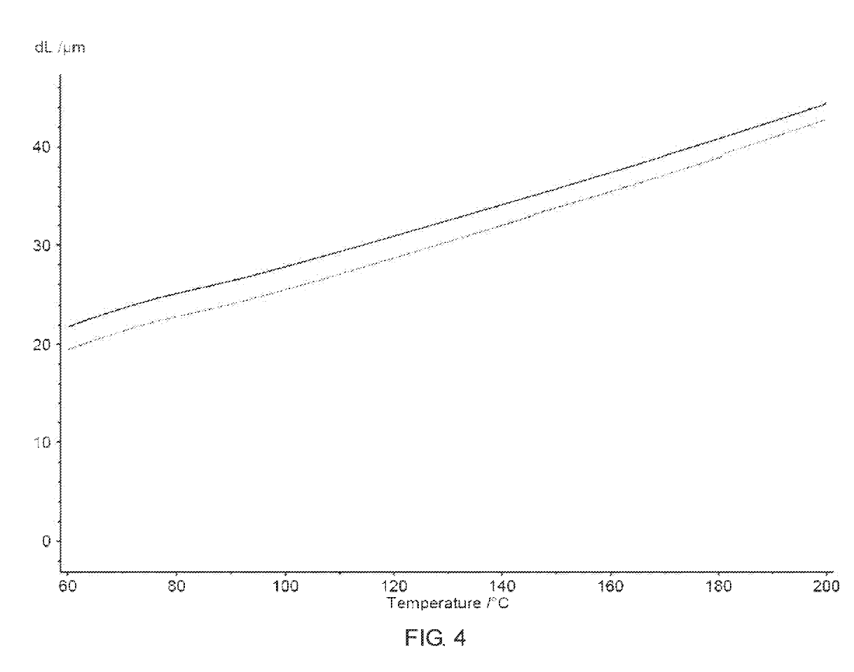

Curves for the determination of the coefficient of thermal expansion are shown in FIG. 4.

### EXAMPLE 5

A sample film having a thickness of 73 μm was prepared in the same manner as described in Example 1 except that glass cloth made of E glass (thickness 20 μm, refractive index 1.560, HP-Textile HP-P48E, Plain, 48 g/m²) was used for impregnation. Resin composition of 67.4% by weight of Desmodur N3900, 32.4% by weight of Desmophen VPLS2249/1 and 0.02% by weight of silicone free defoamer BYK 052 was used. The film had a coefficient of thermal expansion of 14.9 ppm/K, and a total light transmittance of 87.2%.

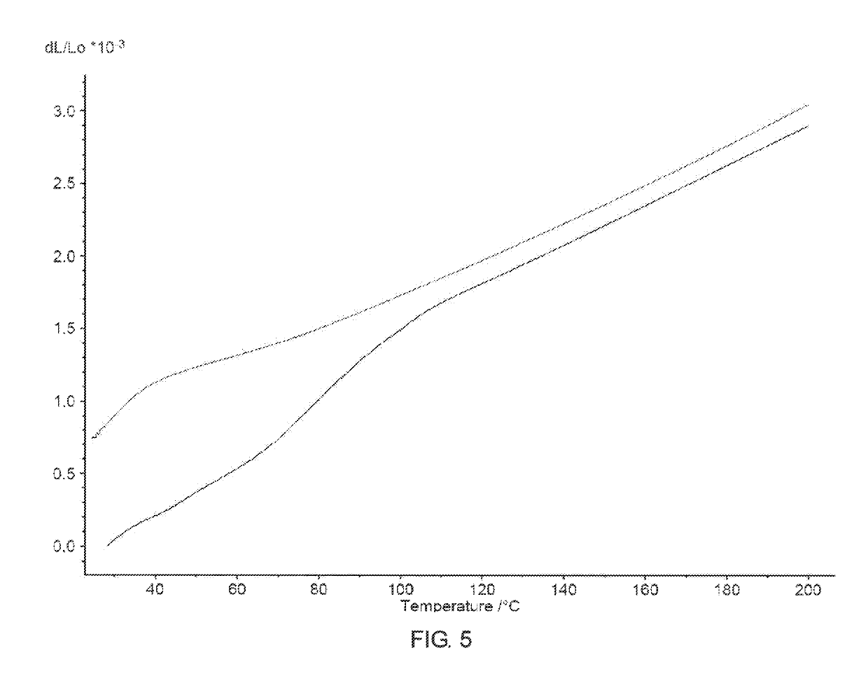

Curves for the determination of the coefficient of thermal expansion are shown in FIG. 5.

The following tables summarize the experiments and the results obtained.

TABLE 1

| | NCO/OH | | | |
|---|---|---|---|---|
| Example | Ratio | Isocyanate | Polyol | Glass fiber |
| 1 | 1.20 | Desmodur | Desmophen | Hexforce |
| | | N3900 | VPLS2249/1 | H4180 |
| 2 | 1.05 | Desmodur | Desmophen | Hexforce |
| | | N3900 | XP2488 | H4180 |
| 3 | 1.05 | Desmodur | Desmophen | Hexforce |
| | | NZ1 | PLS2249/1 | H4180 |
| 4 | 1.05 | Desmodur I | Desmophen | Hexforce |
| | | | VPLS2249/1 | H4180 |
| 5 | 1.20 | Desmodur | Desmophen | HP-Textile |
| | | N3900 | VPLS2249/1 | HP-P48E |

TABLE 2

| | | Transmittance | | |
|---|---|---|---|---|
| Example | Thickness (μm) | (%) | CTE (ppm/K) | Cracking |
| 1 | 141 | 90.1 | 6.0 | No |
| 2 | 199 | 90.6 | 8.9 | No |
| 3 | 85 | 88.6 | 7.3 | No |
| 4 | 87 | 86.0 | 7.5 | No |
| 5 | 73 | 87.2 | 14.9 | No |

1.-15. (canceled)

16. A composite film comprising a matrix and a glass filler at least partially embedded in the matrix, wherein the matrix comprises a cross-linked polyurethane polymer, wherein the composite film has a light transmittance of more than 80%, a coefficient of thermal expansion of less than 40 ppm/K and the film has a thickness of less than 500 μm.

17. The film according to claim 16, wherein the glass filler is present in form of glass fabrics, non-woven clothes, glass monofilaments or chopped glass fibers.

18. The film according to claim 16, wherein the glass filler is present in form of glass fabrics having a thickness of 10 to 200 μm.

19. The film according to claim 16, wherein the polyurethane polymer has been prepared from a mixture comprising at least one aliphatic polyisocyanate and at least one polyester polyol.

20. The film according to claim 16, wherein the polyurethane polymer has been prepared from unsaturated polyurethane based resins.

21. The film according to claim 16, wherein the film might further comprises at least one coating layer.

22. A process for the manufacture of a composite film, comprising the following steps:
preparing a resin composition for a cross-linked polyurethane matrix, the resin composition comprising a polyisocyanate, preferably an aliphatic isocyanate, a polyol and optionally a defoamer, a thermostabilizer and a wetting agent;
providing a glass fabric or non-woven glass cloth;
contacting said glass fabric or non-woven glass cloth with the resin composition;
curing the resin composition;
wherein the obtained film has a light transmittance of more than 80%, a coefficient of thermal expansion of less than 40 ppm/K and a thickness of less than 500 μm.

23. The process according to claim 22, wherein the glass fabric or glass cloth has a thickness in the range of from 10 to 200 μm.

24. The process according to claim 22, wherein the curing step comprises thermal curing and/or radiation curing.

25. The process according to claim 22, wherein the contacting said glass fabric or non-woven glass cloth with the resin composition is conducted on a support and the support is a release film.

26. The process according to claim 22, wherein the resin composition comprises at least one aliphatic isocyanate and at least one polyester polyol.

27. An assembly comprising a support and an optical element supported by the support, wherein the support comprises a composite film comprising a matrix and a glass filler at least partially embedded in the matrix, wherein the matrix comprises a cross-linked polyurethane polymer and wherein the composite film has a light transmittance of more than 80%, a coefficient of thermal expansion of less than 40 ppm/K and a thickness of less than 500 μm.

28. The assembly according to claim 27, wherein the composite film is a composite film according to claim 16.

29. The assembly according to claim 27, wherein the optical element is a liquid crystal element, a color filter, a touch panel element, an electroluminescent element, a light emitting diode, an organic light emitting diode, an electrophoretic display element, a thin film transistor, a lens element or a photovoltaic element.

30. An electronic device comprising an assembly according to claim 27.
